(19) United States
(12) Patent Application Publication
(10) Pub. No.: US 2007/0198952 A1
(43) Pub. Date: Aug. 23, 2007

(54) Methods and systems for authoring of a compound document following a hierarchical structure

(76) Inventor: Robert Allan Pittenger, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/358,158

(22) Filed: Feb. 21, 2006

(51) Int. Cl. G06F 3/048; G06F 17/00

(52) U.S. Cl. 715/853; 715/513; 715/781

(57) ABSTRACT

Embodiments generally relate to improvements in methods and systems for authoring hierarchical documents. According to one embodiment, computer software applications, and accompanying data structures and GUI components, are provided for the development by multiple authors of one or more hierarchical documents within a client-server database environment or Internet environment. The application provides a visual display showing the hierarchical structure of the content document and a visual display showing the hierarchical structure of a guidance document. Subsections of the content document are linked to subsections of the guidance document, via linked data structures, such that the two can be easily correlated and viewed whenever a subsection is selected. Guidance information is displayed adjacent to an edit window to allow users to view appropriate guidance while editing content. Tasks can be assigned and displayed directly in the displayed hierarchy. Also, the master document is automatically generated from various subdocument electronic files

### TECHNICAL FIELD

Embodiments of the invention relate to the authorship of hierarchical documents, and in particular, one or more embodiments relate to the collaborative development of such documents within a client-server or web-based environment following a hierarchical model and through use of linked guidance documents and document-based task management.

### BACKGROUND

Many documents can be organized in a hierarchical structure, such as by dividing the document into subsections. Each subsection can be further divided into subsections. Although further division can continue as desired down to the smallest possible subsection of a single character, often the most practical ultimate subsection is a single paragraph. Often, such sections are numbered in a hierarchical sequence such as:

1.

1.1

1.1.1

1.1.2

2.1

2.2.

2.2.1

etc.

However, other alphanumeric sequences are common.

Various programs using hierarchical document structures are known. Some utilize a text-editor having built in capabilities for formatting of text adjacent to a tree diagram showing the hierarchy of the document, and require a display of the composite document. Others allow different users to write “notecards” which are then linked to the document by “placeholders,” and utilize a display window to show the assembled document within the program. Still others utilize a hierarchical display that is produced using a tabbed metaphor

However, hierarchical document authoring programs typically do not easily permit simultaneous authorship, or permit the inclusion of subdocuments into a complex compound document, being limited to raw text instead. Accordingly, such programs are limited in capabilities, and inclusion of subdocuments, such as additional computer files, formatted text, spreadsheet files, pictures, diagrams and other types of complex digital content can be difficult or impossible with such programs. In addition, such programs merely provide a hierarchical editor for authoring a document rather than providing guidance for authoring the content of each subsection or tasks for each document subsection. If a guidance document was provided it might be referenced from master document subsections either as an entire guidance document, or itself broken up into subsections cross-referenced to subsections of the master document. However, such an embodiment does permit authors to simultaneously view the guidance document or its hierarchy, and therefore it can be difficult to view and understand the guidance document, which can often be complex. Furthermore, the document being authored may require that certain authorship tasks be assigned and tracked for a plurality of users. But typically such programs can not provide an easy way for such tasks to be easily tracked or viewed or coordinated with the document being created, particularly for multiple users.

Accordingly, prior hierarchical authoring tools frequently suffer from limited or no ability to allow for efficient collaborative authorship or provide guidance in developing a complex document, such as one that includes subdocuments. Consequently, developing documents with such tools, particularly developing complex documents, could be time consuming and burdensome. Therefore, improved hierarchical document authoring methods and systems for complex documents are desired.

### SUMMARY

Accordingly to some aspects, a software program is provided that can simplify the creation of the subdocuments of a complex document by linking relevant portion of subdocument content to guidance indicating what should be included in the subdocument.

According to additional aspects, a program is provided that simplifies access and organization of the subdocuments by displaying a hierarchical document structure showing the position of the subdocument with respect to the overall document structure.

According to one or more additional aspects, a software program is provided that automatically generates the master document from the subdocuments. Each subdocument is placed in the proper position in the master document based on its position in the hierarchical document model, and the master document is automatically generated.

In accordance with one or more additional features, a program is provided that incorporates task management into document generation by include task representations directly within the hierarchy of the document structure.

In accordance with additional aspects, a collaborative environment is provided to allow a plurality of users to develop a complex document, with each user responsible for authoring one or more subsections comprising subsections. The collaborative effort allows the document to be created more quickly, and with the appropriate expertise for each subsection. Furthermore, content authored by the each user may be driven by one or more guidance document that in whole or in part describe requirements for the authored document. In such a case, it can be desirable that users authoring the document be able to quickly reference the appropriate sections or subsections of the guidance document. According to this aspect, the program provides a greatly improved visual display of the hierarchy of the guidance document while simultaneously displaying the hierarchy of the master document.

Moreover, it may be desirable that assigned tasks be linked to subsections of the document under collaborative development or to subsections of a guidance document such that users can quickly reference tasks associated with a section of a document and/or such that users can quickly reference subsections of a document associated with assigned tasks.

According to another aspect it is desired to automatically assemble the content document subsections into one single hierarchical master document using a linked guidance document, and to permit the subsections to be composed of complex graphic artifacts such as tables, spreadsheets, images, figures, other files, or a variety of other types of representations.

In one embodiment, a computer readable medium is provided that has encoded thereon a method for generating a document. The method comprises displaying a hierarchy indicating the organization of a master document, the hierarchy including an indication of the sections of the master document. The method further comprises receiving an input from a user indicating a selection of one the sections, and in response to the input, displaying at least a portion of a guidance document, the portion displayed including instructions for authoring the selected section of the master document.

In another embodiment, a computerized method is provided for authoring a complex document. The method comprises displaying a hierarchy for a master document to be generated, the hierarchy including sections of the master document, each section defining a particular topic to be addressed in the document. The method further comprises receiving subdocuments for each section of the master, the subdocuments comprising computer files. In addition, the method comprises automatically assembling the subdocuments to form a single master document.

According to another embodiment, a computerized method for authoring a complex document is provided. The method comprises displaying a hierarchy for a master document to be generated, the hierarchy including sections of the master document, each section defining a particular topic to be addressed in the document. The method further comprises receiving selection inputs from multiple separate users, the selection inputs indicating selections of one or more sections of the master document, and receiving subdocuments from each of the multiple separate users, the subdocuments representing content to be placed at the corresponding selected section of the master document. The method also comprises automatically linking all of the subdocuments to form the master document.

In accordance with another embodiment, a computerized method for authoring a complex document is provided. The method comprises displaying a hierarchy for a master document to be generated, the hierarchy including sections of the master document, each section defining a particular topic to be addressed in the document. The method further comprises displaying tasks in the hierarchy adjacent corresponding sections of the master document, the tasks providing instructions to authors regarding the section to be developed. In addition, the method comprises receiving selection inputs from multiple separate users via a network, the selection inputs indicating selections of one or more sections of the master document. In response to each selection input, at least a portion of a guidance document is displayed to the user, the portion displayed including instructions for authoring the selected section of the master document. The method also comprises receiving computer files from each of the multiple separate users, the files representing content to be placed at the corresponding selected section of the master document, and assembling all of the files to form the master document.

### BRIEF DESCRIPTION OF THE DRAWINGS

While the specification concludes with claims particularly pointing out and distinctly claiming the present invention, it is believed the same will be better understood from the following description of examples taken in conjunction with the accompanying drawings wherein like numerals indicate corresponding elements and wherein:

FIG. 1 is a schematic diagram showing one embodiment where a plurality of users collaboratively access a complex document authorship application and related document and linked guidance data using a client-server database network;

FIG. 2 is a schematic diagram showing an illustrative embodiment similar to that of FIG. 1, but where the plurality of users access the data and application using computers connected to the Internet;

FIG. 3 is a block diagram illustrating the hierarchical structure of an example document hosted by the application;

FIG. 4 is a block diagram illustrating how tasks can be incorporated in the hierarchical structure of the document, according to some embodiments;

FIG. 5 is a block diagram illustrating the linking of documents held in a database repository to one or more nodes of the hierarchical document in a many-to-many relationship relating document sections to guidance documents, according to some embodiments of the present invention;

FIG. 6 is a block diagram illustrating an embodiment where a guidance document is broken down into a hierarchy of subsections for display along with a hierarchy of sub-documents under collaborative development;

FIG. 7 is a block diagram illustrating a relational database table structure supporting a hierarchical document structure and a repository of guidance documents, following the scheme illustrated in FIG. 5 and according to some embodiments;

FIG. 8 is a block diagram illustrating an embodiment of a relational database structure for combining a hierarchical document of content and guidance with cross links shown in FIG. 6;

FIG. 9 is a block diagram showing how task information can be incorporated into the relational database structure, according to some embodiments;

FIG. 10 is a block diagram showing another embodiment of a data structure wherein tasks are linked to subsections of the master document in a many-to-many relationship;

FIG. 11 is a diagram illustrating Graphical User Interface (GUI) components that allow users to edit content for a node of the document using software running on a client computer, such as illustrated in FIG. 1, according to some embodiments;

FIG. 12 is a diagram illustrating Graphical User Interface (GUI) components that allow users to edit content for a node of the document using a web-based interface through a common Internet web-browser application running on a client computer, such as illustrated in FIG. 2, according to some embodiments;

FIG. 13 is a diagram illustrating a graphical user interface for hierarchical display of the master document and the guidance document, as well as simultaneous display of a text viewer or editor, in accordance with some embodiments;

FIG. 14 illustrates an example of a computer display showing an example of a master document structure along with corresponding guidance document structure, similar to the example of FIG. 6; and

FIG. 15 illustrates an example of a computer display showing a content window for entering content for a section of the master document while simultaneously viewing guidance information for the section.

### DETAILED DESCRIPTION OF ILLUSTRATIVE EMBODIMENTS

In general, embodiments relate to improvements in methods and systems for authoring hierarchical documents. According to one embodiment, a computer software application and accompanying technology is provided for the collaborative development of one or more hierarchical documents within a client-server database environment or Internet World Wide Web-application environment. The application includes a visual display showing the hierarchical structure of the document. The document is broken into hierarchical subsections with each subsection title displayed as a node in a hierarchical tree display. To permit collaborative authorship of the document, a user can access a node of the document and use menu commands to enter or edit text content for that subsection of the document. The application of this embodiment further includes a visual display showing the hierarchical structure of a guidance document. Users can expand the hierarchical display to quickly access desired sections of the guidance document. The application includes a capability to link subsections of the master document to subsections of the guidance document, such that the two can be easily correlated and viewed. Moreover, the application includes the capability to display guidance information from a guidance document adjacent to an edit window to allow users to view appropriate guidance text at the same time that they edit document text, following the instructions provided in the guidance documents. The application further allows subsections of a document to include graphic artifacts and not just text. Moreover, the application of this embodiment includes a capability to assign and track tasks at any level in the hierarchy of the document under collaborative development or at any level of the guidance document. In addition, the application includes a design for the storage of data structures, and corresponding user interface components, supporting the above actions, as well as the capability to automatically generate a single document from subdocuments.

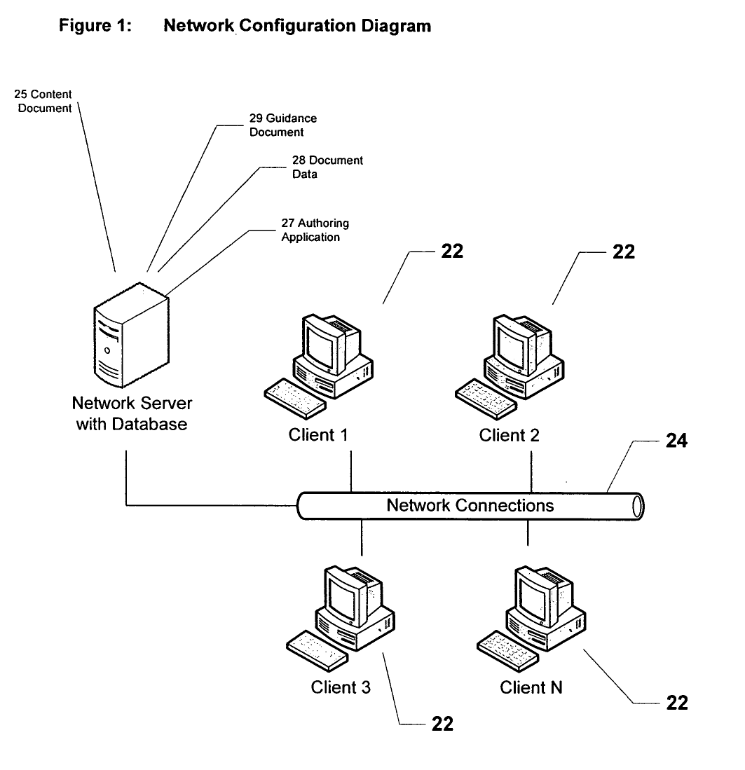

FIG. 1 shows a client-server database network in which the methods and systems of the present embodiments may be implemented. A plurality of client computers 22 connect to a network 24 and communicate with a server computer 26. In one embodiment, the server computer 26 hosts the database software 27 and data 28. The software 27 allows the client computers 22 to collaboratively access a hierarchical content document, master document, or composition document 25, and to view guidance document instructions 29 for each section of the document 25, the data 28 providing the linking between the content and guidance documents. Each section of document 25 can then be assembled into a master document which joins the content sections in the proper hierarchical order. The guidance document 29 includes information to guide the authors in writing content for the document under development, or in guiding users in the performance of tasks assigned to sections of the document. For example, the guidance document 29 may state what is to be included in a particular section of a document or may provide questions that must be answered in the document.

Because the software permits collaborative authorship, the document can be authored by one or more people. Each may be responsible for individual sections or subdocuments, or the team as a whole may be responsible for the entire master document. Due to the client/server architecture, content may be stored on server computers 26 accessible through a network. Users are able to access, modify, and create content using specially designed client software operating on the client computers 22 connected to the server network 24. Users are able to access, modify, or view the master document hierarchy using specially designed client software operating on client computers 22 connected to the server network 24. In another embodiment, data 28 is hosted on a different server computer 26 but connected to the main server 26 and network 24. Separating relational data 28 from the network server 26 can improve security and data protection.

In particular, to allow for collaborative authorship, and as will be described in more detail below, each node in the hierarchical document tree corresponds to one record in a relational database table. Collaborative authorship is permitted because common relational database technology allows different users to simultaneously modify data in different records in the same database table. Therefore, two users can simultaneously make changes to different sections of the document. At the time of editing data for a record, relational database technology permits the locking of the record so that no other user can modify data for that record simultaneously. When one user begins to edit a document section, the database record in the appropriate table is locked so that no other user can modify the data simultaneously with the undesired outcome of one user overwriting another users changes. When the first user has completed the changes to the record, the table is updated and the record is unlocked allowing other users to repeat the process.

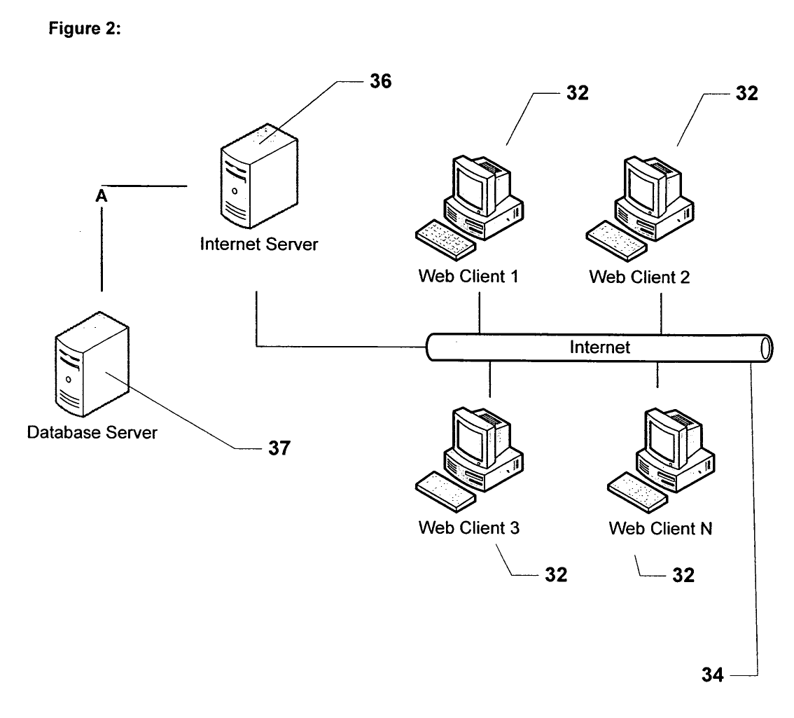

FIG. 2 shows one embodiment where a plurality of users access the data and application using computers 32 connected to the Internet 34, which likewise can be utilized with the data structures, methods, and systems described herein. The client computers 32 use a common web browser application such as Microsoft Internet Explorer to provide a user interface for the application. The application is hosted on a server computer 36 and operates with web-server software to interact with the web browser software. The data and documents can be stored on the same computer as the web server 36, or the database can be stored on a separate server computer 37 connected to the web server computer illustrated with connection A, to improve security and data protection. Thus, in this Web-based environment, the content may be stored on server computers 36 accessible through the Internet. Users are able to access, modify, and create subdocument content for a document section using the web browser software application. Moreover, according to this embodiment, users are able to access, modify, and/or view the master document hierarchy, tasks therein, and linked document hierarchy using a web browser software application.

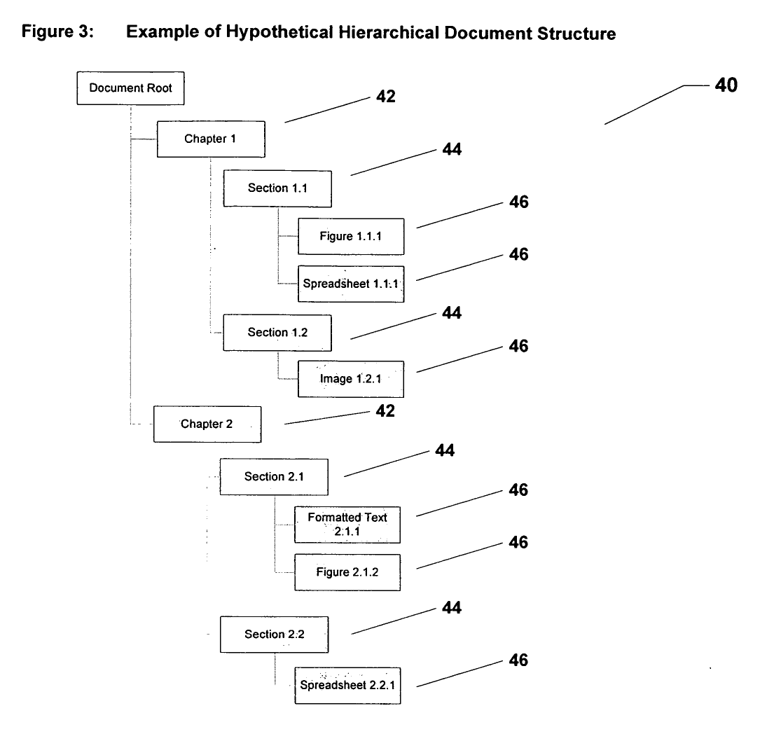

FIG. 3 illustrates an example of a hierarchical structure 40 of a hypothetical master document that may be viewed and created according to principles of the present invention. The document structure 40 includes two chapters 42, and each chapter has two sub-sections 44. Each such document 46 may be considered a subdocument, which can be a single computer file of type unformatted text, formatted text, spreadsheet, diagrams, image, picture, or any other type of digital content. The subdocument 46 can be authored with the purpose of becoming part of a master document, which is a large document created by combining subdocuments 46 or subsections in the proper order. The ultimate objective of the software application embodiments of the present invention is to expedite and facilitate the creation of the master document. Any user of the application may use it to more easily write a subdocument or any portion of a subdocument 46, or create tables, figures, or other entities that constitute the subdocument. Thus, graphic artifacts of the subdocuments can then be combined into a master document using one or more embodiments described herein. A graphic artifact can be any document such as tables, spreadsheets, images, figures, formatted text, or a variety of other types of representations that can be incorporated into a single document using Word processing software with the appropriate technology. For example, a Microsoft Excel spreadsheet is a graphic artifact in that it can be a standalone computer file but can also be embedded in a word processing document created in Microsoft Word or a variety of other popular word processing programs.

According, as shown in FIG. 3, not only may the subdocument 46 have a hierarchical structure, but the subdocument itself is part of a hierarchical document model, meaning that each subdocument file 46 of the master document is automatically placed in the correct position in the generated final master document based on its position in a hierarchical model 40. According to at least some embodiments, the hierarchical model 40 is displayed to the user by the software application to convey the master document structure. The content to be created is a portion of a subdocument 46 or master document created by an author. A content document is therefore any subdocument 46 that is written by authors using the software application, and itself may have subsections. As will be described further, in some embodiments, the application may access a guidance document, which is a document that explains to authors what is to be written in the content document.

Therefore, the application executed in the embodiments of FIGS. 1 and 2 can be used to create a master document having a hierarchical structure 40 such as shown in FIG. 3 and including subdocuments 46. The application can also combine the subdocument 46 with other subdocuments to form a master document. In addition, the application can display to the users one or more guidance documents to assist the users in building the subdocuments and the master document. Thus, embodiments of the invention can create a complex compound document having content that is not limited to raw text, but may also include subdocuments including files, formatted text, spreadsheet files, pictures, diagrams, or any other types of digital content. In this embodiment, the subdocuments 46 are assembled into the final master document using the word processing application software that supports object-embedding technology. Using object embedded technology allows the application to assemble the document components into the final document. Any appropriate technology can be used for this purpose, such as Microsoft's Object Linking and Embedded (OLE) for example.

In this example, the document assembly process begins with the application establishing a connection to a word processing application such as Microsoft Word. The connection can use a technology referred to as COM Automation in Microsoft Windows, but similar technologies can be utilized for other platforms. COM Automation allows the application to take control of Word and automate processes in the word processing software that would otherwise be performed manually by a user. The application creates a new document in Word. The application reads all database records for the tree and inserts the appropriate text in the appropriate position in the Word document. In the case of graphic artifacts, the application is able to insert the graphic artifacts in the appropriate position in the Word document. When the document is complete, the application uses COM Automation to instruct Word to save the document. With the process complete, the COM Automation connection is closed.

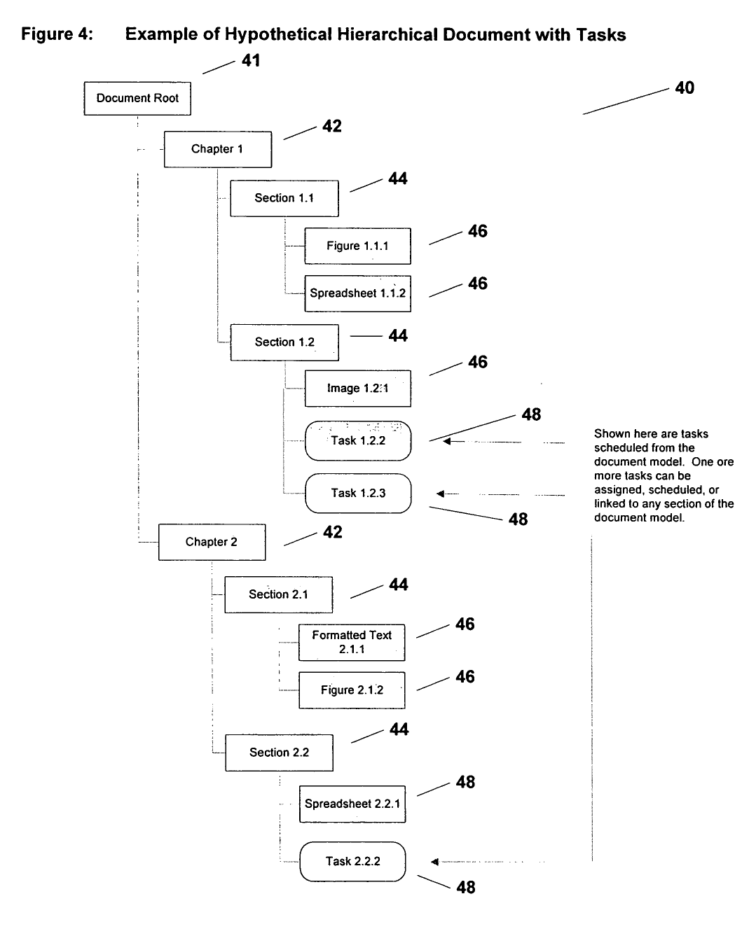

FIG. 4 is a block diagram showing how, in accordance with one embodiment, the software application can allow one or more tasks to be incorporated into the hierarchical structure 40 of the master document. This embodiment allows users in authority to schedule tasks 48 for indicating to authors what is to be done to complete a section of the document. In this embodiment, each such task 48 comprises instructions, such as in text format, linked to the corresponding appropriate specific sections 44 of the document. Tasks 48 can be assigned to one or more of the users of the application with access to the system. In particular, tasks 48 can be assigned to the user assigning the task, or to another user, or to a group of users. Moreover, tasks 48 may be one-time events or recurring tasks. There are at least two common environments where such an embodiment can be particularly useful:
1. In a regulatory environment, for example, many documents have sections 44 that specify tasks 48 that need to performed. Users in authority can schedule tasks to users for actions that must be performed to maintain compliance with the document.
2. In a collaborative development environment, tasks 48 can be assigned to the document authors to complete particular sections 44 of the document, perform fact-checking, or add or complete images, tables, figures, spreadsheets, or any other component of the document.

In the example of FIG. 4, point A shows the root 41 of the document hierarchical structure. Items labeled B are individual tasks 48 associated with subsections 44 of the document. Tasks 1.2.1 and 1.2.2 are assigned to document subsection Image 1.2. Task 2.2.1 is assigned to spreadsheet 2.2. Accordingly, FIG. 4 allows tasks to be linked to one or more sections of the document, such that they are displayed to the user in the hierarchy showing the document structure. The task may be related to authorship of the document, such as instructing an author to make particular changes to a section of the document. The task may also be governed by the document. For example, the document may provide instructions for the task. The task can represent an action scheduled to be performed in the future, or it can represent some action that has occurred in the past.

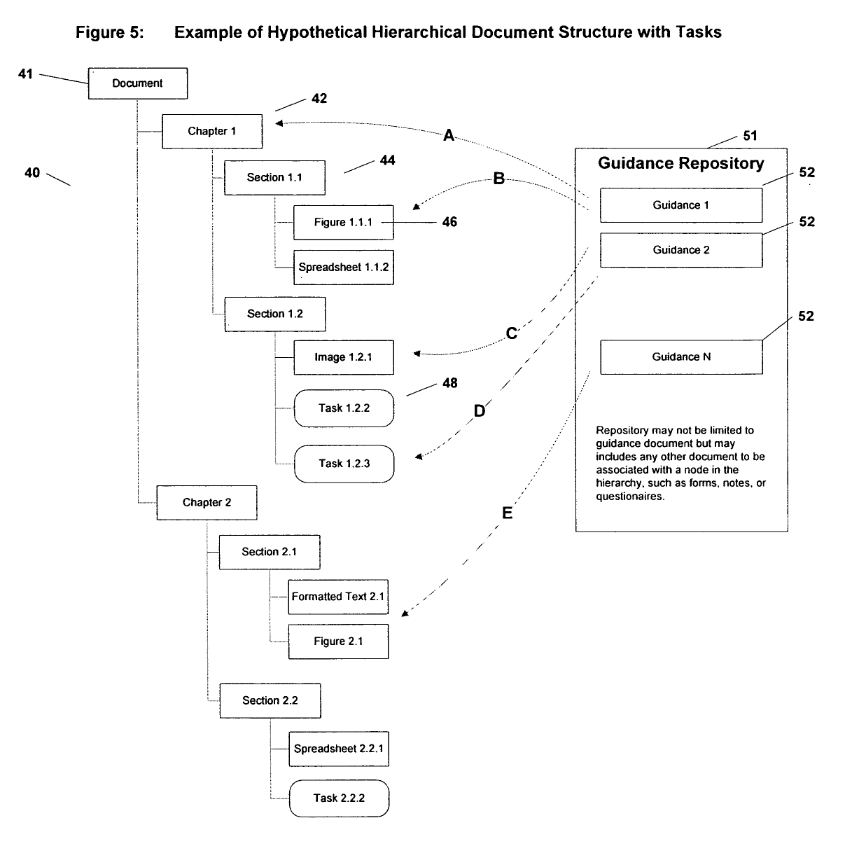

In a collaborative document development environment, it can be desirable that creation of the hierarchical document be dictated and instructed by one or more guidance documents. FIG. 5 shows how in combination with some embodiments of the invention, guidance documents 52 held in a database repository 51 can be linked to one or more nodes of the hierarchy of the master document 40 in a many-to-many relationship linking document sections 42 to guidance documents 52. Lines A through E show how guidance documents 52 labeled 1 through N may be linked to any document content 46 or task nodes 48 in document hierarchy G.

As will be described in further detail below, the link between a content document node and a guidance document node can be maintained in a separate table in the database 51. The table includes a field for the unique ID of the content node and the unique ID of the guidance node allowing a many-to-many relationship between content nodes and guidance nodes. Task data can be stored in a separate table. The task data table can include a field for a unique task ID. The task data table can also include a field for the unique document node ID of the section of the document that owns the task (a task could be linked to a content node or a guidance node or any other type of node supported in the application). This type of relationship restricts tasks to only one document node. Alternatively, tasks could be linked to document nodes in a many-to-many relationship. Such a design could use an intermediary link table with a field for the unique document ID and a field for the unique task ID.

Also, guidance documents 52 can be linked to document sections 42 as with line G or to figures or other entities as shown with lines B, C and E. In one embodiment of the invention, guidance documents 52 can be referenced from task nodes 48 as well as content nodes 46, as shown with line D, to provide users with guidance on how to perform a task.

The guidance document repository 51 need not be restricted to guidance, but may also include documents to be created as part of the task or collaborative document authorship process, such as forms or questionnaires that are filled out as part of the task, or reference notes created as part of the document development.

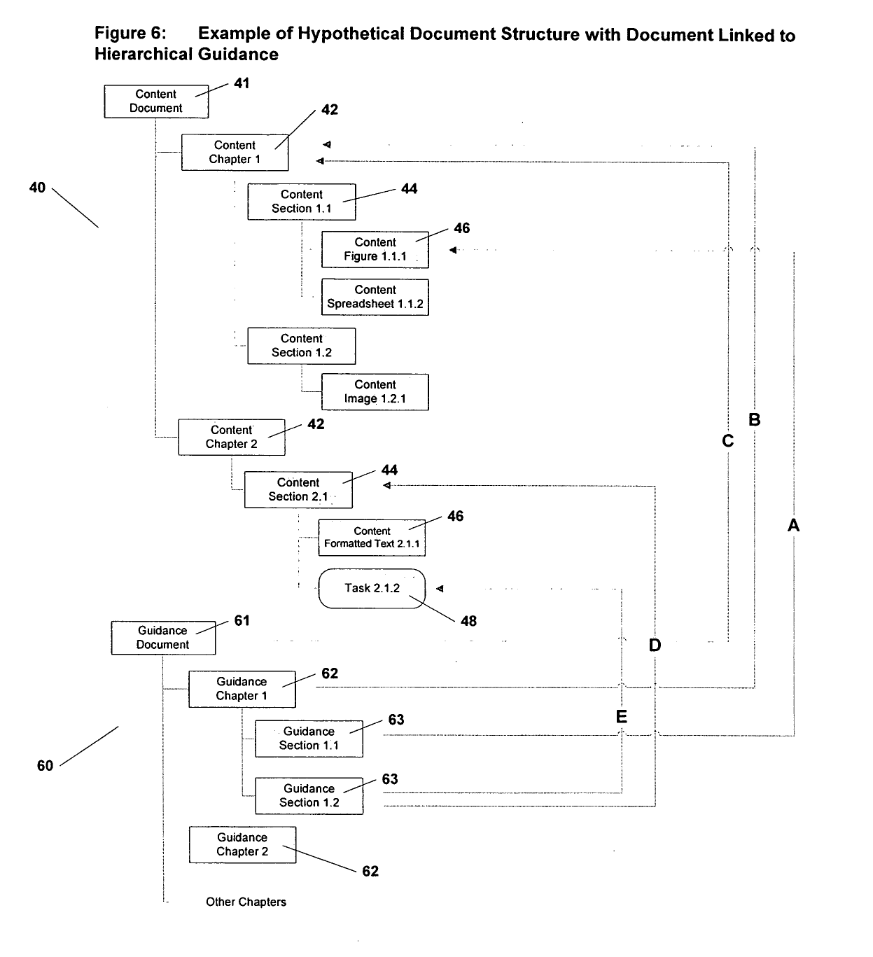

Like the master document, the guidance document may itself follow a hierarchical structure. Accordingly, it may be useful to simultaneously display to users the hierarchical structure 60 of one or more guidance documents along side the hierarchical structure 40 of one or more documents under development. FIG. 6 shows how in some embodiments a guidance document can be broken down into a hierarchy 60 of subsections for display along with a hierarchy 40 of sub-documents under collaborative development. This embodiment enhances the visual display by enabling the linking of sections 61-63 of the guidance document to sections of a master document in a many-to-many relationship as show by lines A through E. For example, line A links guidance section 1.1 to FIG. 1.1 with the purpose that guidance section 1.1 described how to create FIG. 1.1. (That both the guidance section and the FIG. both are number 1.1 is coincidence in this example. There is no requirement that the numbers match). Thus, in these embodiments, both hierarchies 40 and 60 can be simultaneously displayed on the same computer screen, with indicators the relationship between the sections of each, such as via lines, colors, aligning rows, etc.

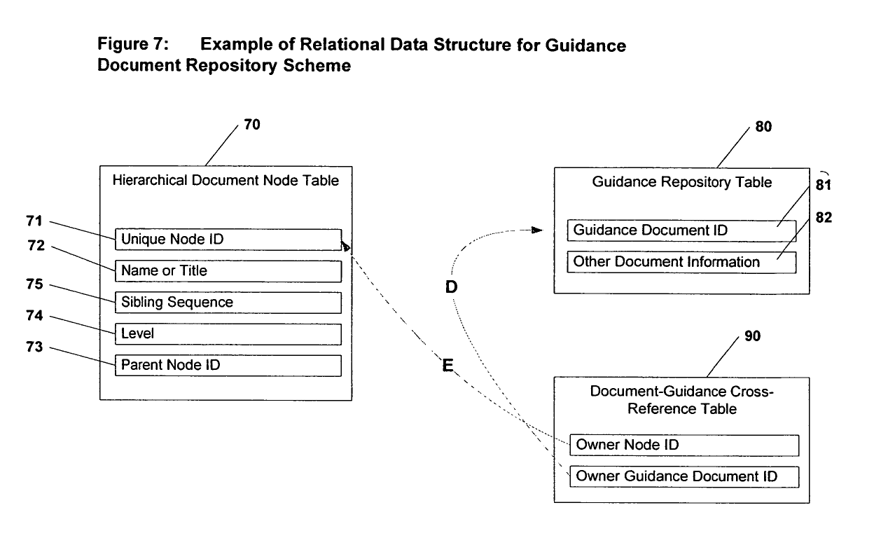

As mentioned, embodiments may use a relational database for data storage and linking of corresponding hierarchical sections of documents. FIG. 7 shows a basic relational database table structure that can be used to support a hierarchical document structure and a repository of guidance documents following the scheme illustrated in FIG. 5.

Data table 70 includes the data for the hierarchical document model. The data fields 71-73 in the example table 70 are:

Node ID 71—A unique identifier of the node of the tree.

Sibling Sequence 72—An ordinal value that indicates the position of a hierarchy node in relation to other nodes at the same level of the tree.

Parent Node ID 73—The identifier of the parent node of the tree.

If the Node ID field 71 of this example is removed, it renders the Parent Node ID field 73 useless. If either the Sibling Sequence field 72 or the parent node ID field 73 are removed, the position of the node 71 in the tree can not be precisely determined as multiple nodes will have the same parent node ID 73 but differ in their sibling sequence value 72. Likewise multiple nodes will have the same sibling sequence value 72 but differ in their parent node 73. Each node 71 will have a unique combination of sibling sequence 72 and parent node ID 73.

A fourth field 74 can be used to indicate the level of the node in the hierarchy. The presence of the Level field 74 can reduce the number of queries that are executed to build the tree for display.

In addition to fields 71-74, a human readable name field 75 and any other datum may also be stored with the document section.

FIG. 7 also shows an example of a guidance repository table 80 that can be used to provide the linking shown on the embodiment of FIG. 5. Each record in the table 80 represents one complete guidance document. One field 81 is used to provide a unique guidance document ID and any additional fields 82 may be used to include the guidance document data.

The additional table 90 in the example of FIG. 7 provides the links from records in table 70 to the guidance repository Table 80 allowing for a many-to-many relationship. In other words, any guidance document in table 80 can be linked to any number of document nodes in table 70 and any document node in table 70 can be linked to any number of guidance documents in table 80.

Accordingly, the exemplary relationship data tables 70 and 80 and 90 can provide needed links or relationship among guidance documents and master document sections, such that the instructions in the guidance document can be displayed whenever a section of the master document is selected. Accordingly, the user can easily view and browse the master document hierarchy while corresponding guidance is provided that relates to the section of the master document hierarchy being viewed.

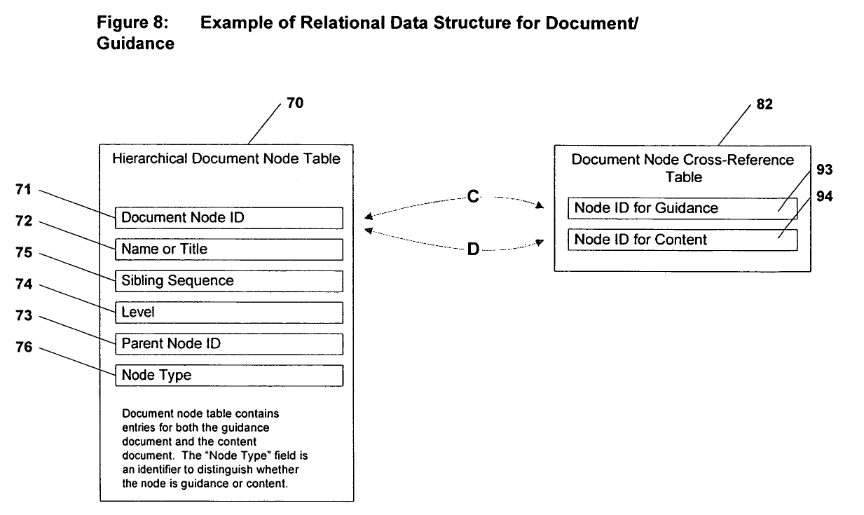

FIG. 8 shows another example of a relational database structure for the linking of the hierarchical master document and to guidance document, such as to obtain the linking of FIG. 6, using cross links. In this example, nodes for the various content documents of the master document and the guidance documents are stored in a single document data table 70A using the fields 71-75 described in FIG. 7. The table 70A adds a field Node Type 76 to indicate if the node belongs to a content document and therefore allows for editing by a user, or if the node belongs to a guidance document and therefore can not be edited.

Data table 92 of the example of FIG. 8 includes the cross-reference data for matching content node Ids 94 to guidance node Ids 93 allowing a many-to-many relationship such that any content node can be linked to any number of guidance nodes and any guidance node can be linked to any number of content nodes. Accordingly, a section of the master document hierarchy can be viewed and displayed in relation to its corresponding guidance information, and whenever a user selects that section, the corresponding guidance can be displayed to the user such that the user can easily view the corresponding instructions for completing the section of content. Whenever the user selects a different section of the hierarchy to be viewed, such as by clicking on a different section using a mouse or other input device for example, the display can also automatically switch to a view of the corresponding guidance for that section.

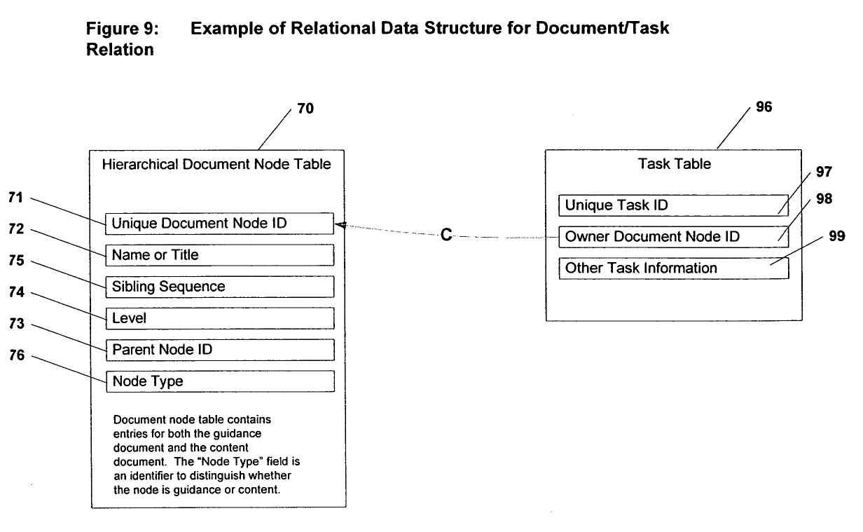

FIG. 9 shows how task information can incorporated into the relational database structure, according to some embodiments. In FIG. 9, table 70 is the same as in FIG. 8, except that the Node Type field 76 now operates in a tertiary manner indicating which of the following types the node is: content, guidance, or task. Table 96 contains task information with the relationship of one record per task. One field 98 contains the node ID of the owner of the task, indicating which document node owns the task. Other fields can be added as required to store necessary task information. In this embodiment, tasks are linked to a document node in a one-to-many relationship so that each task is associated with only one document node but any single document node can be associated with any number of tasks. Accordingly, via such linking, a task can be associated with a section of the document hierarchy and can therefore be viewed and/or displayed in relation to that section such that the association can be shown.

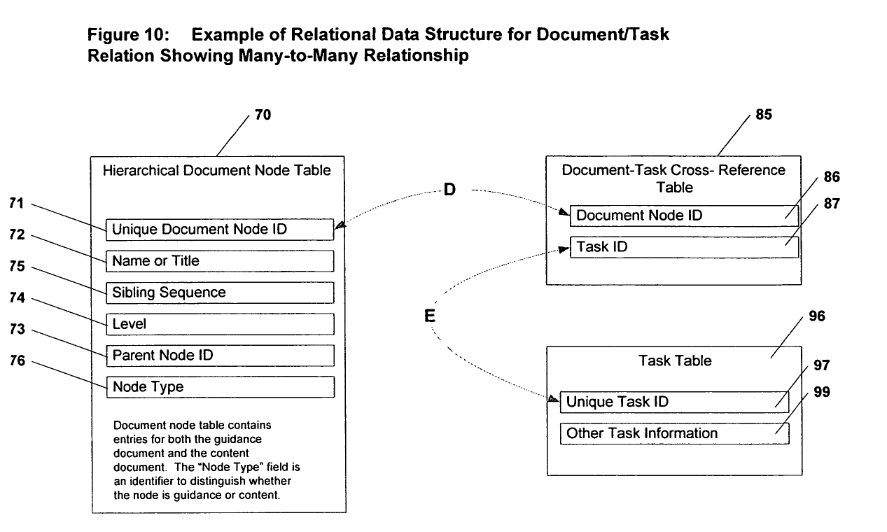

FIG. 10 shows another embodiment of a relational data structure wherein tasks are linked to subsections of the master document in a many-to-many relationship such that any task can be linked to any number of document nodes, and any document nodes can be linked to any number of tasks. Table 70 shows the hierarchical document node table as described in FIG. 7 and 8. Table 96 includes the task information as described in FIG. 9, but with the mission of the Owner Document Node ID field. Replacing the removed field is another table shown as Table 85 which includes one field 86 identifying the document node ID for a task and a corresponding field 87 identifying the task node ID for that task. Accordingly, as shown in FIG. 10, each task in the task table 96 can be linked to a corresponding section of the master document. In this example, this is done by linking the task table entry to a task ID 87 in the cross-reference table 85. The task table entry 87 is then associated with a document node ID entry 86 showing which document node (section) corresponds to that task. Accordingly, in these embodiments, when a document section is viewed, the tasks associated with that section can be simultaneously viewed and/or linked, such that tasks indicating what is to be carried out for a given section can be easily viewed as the section is being viewed. As the user switches from section to section, such as by using a mouse or other input device, the corresponding tasks will be displayed or linked for the sections being viewed.

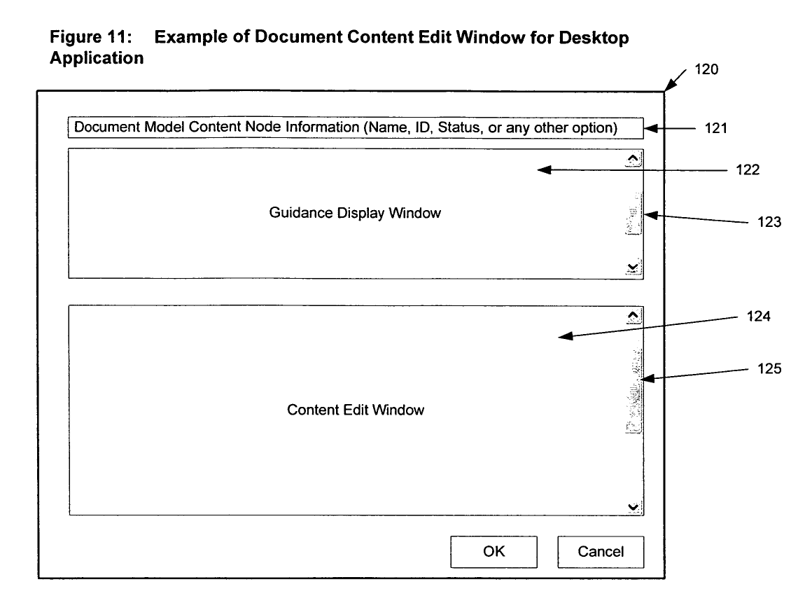

FIG. 11 shows examples of Graphical User Interface (GUI) components that allow users to edit content for a node of the document using a software application running on a client computer as illustrated in FIG. 1, according to some embodiments of the invention. The user may provide a command, such as via a mouse input and/or keystrokes, to edit a node/section of the document. In response to the user's selection of the node, the software application displays editing window 120, accesses the database to retrieve information for the node selected by the user for editing, and displays the name and any other ancillary information in area 121. At the time of display of the editing window 120, the software application follows links for the selected node to get guidance information from one ore more guidance nodes, or from one ore more documents in the guidance document repository, and then displays the corresponding guidance information in the Guidance display window 122. This guidance information provides instructions to the user for completing the section of the document being reference. If the guidance text or information exceeds the display size of window 122, scroll bar 123, or other suitable control, can be used to scroll the guidance text. The software reads the document node information for the selected node and displays the corresponding content (e.g.,. a subdocument, such as text, graphics, etc) for that portion of the master document in User Edit Window 124 for editing by the user. If the content is text and exceeds the display capacity of the window 124, the user can use scroll bar 125 to scroll and reposition the text.

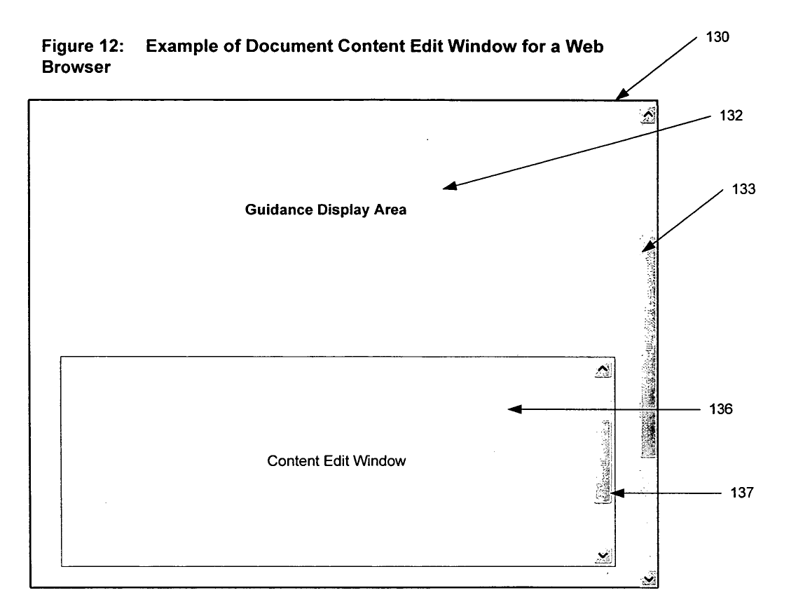

FIG. 12 shows embodiments of Graphical User Interface (GUI) components that can allow users to edit content for a node of the document using a web-based interface generated by a common Internet web-browser software application running on a client computer, such as illustrated in FIG. 2. Window 130 is the client area of the web browser application, and can comprise suitable web browser interfaces such as those provided by Microsoft Internet Explorer. Upon the appropriate user commend to edit content for the node of a document, the software operating on the web server processes commands sent from the client web browser software. The processing of the command retrieves the appropriate document content from the database (such as can be stored on database server 37 of FIG. 2) and the corresponding guidance information for that document subsection can be retrieved, delivered through the Internet connection 34 (FIG. 2), and displayed in the window 130.

Guidance information and any ancillary information can then be displayed in area 132. If area 132 exceeds the available space for display, the user can scroll the content of area A using scroll bar 133. Included adjacent to area 132 is editing window 136, which is also generated via the client web browser, and which allows the user to edit the content of the section of the document while simultaneously viewing guidance in area 132 as positioned by the user with scrollbar 133. If the content in area 136 exceeds the available space, the content can be scrolled in area 136 using scrollbar 137. Accordingly, the GUI of the embodiment of FIG. 12 can allow for display and editing of the content of a selected section of a master document while simultaneously allowing for the display of instructions/guidance to the author for completing that section.

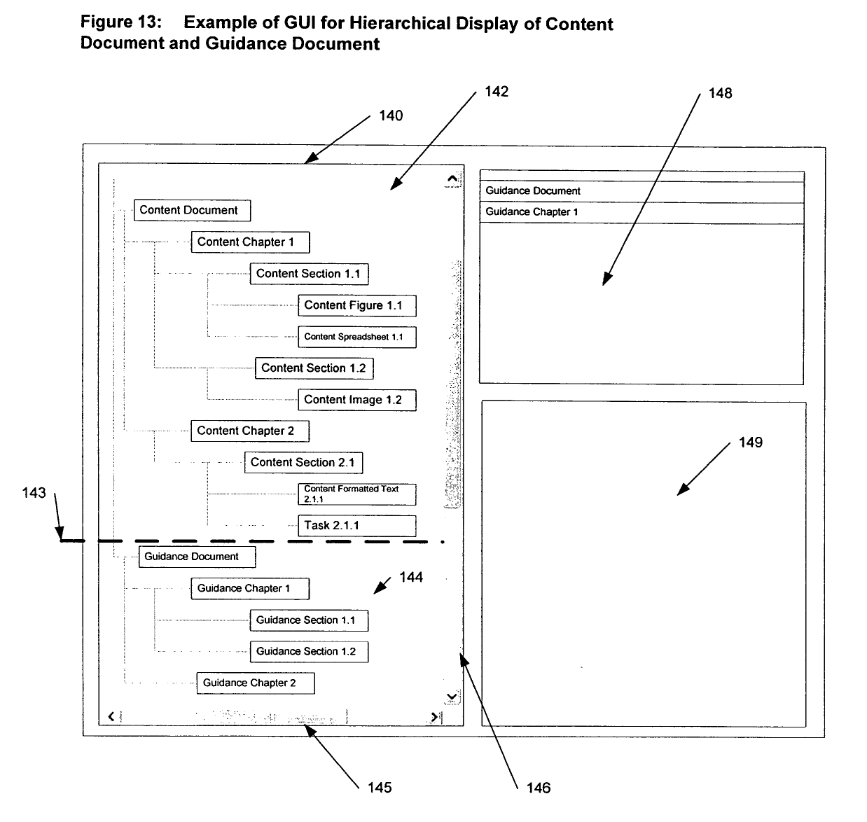

FIG. 13 shows an embodiment of graphical User Interface (GUI) components to display the hierarchy of the master document adjacent to the hierarchy of the guidance document. The hierarchy of the master document and guidance document in FIG. 13 follows the scheme of FIG. 6.

Box 140 represents a tree-style GUI control that can be used in one or more embodiments. Area 142 above line 143 is the portion of the tree control showing the hierarchy of the content document. Area 144 below line 143 is the portion of the tree diagram showing the hierarchy for the guidance document. In other embodiments, the document hierarchy need not be positioned above the guidance hierarchy. The positions can be reversed, or guidance document nodes can be mixed with content document nodes. In these configurations, a visual indicator on each node such as a glyph or icon can be used to indicate the type of node. In this embodiment, scroll bars 145 and 146 are used to scroll the tree vertically and horizontally respectively.

In this example, the GUI also simultaneously displays a cross reference display 148 shown as area 148 in FIG. 13. As a content node is selected in tree area 142, the software causes a list of corresponding guidance nodes that are linked to the selected content node to be displayed in area 148. Likewise, as a guidance node is selected in tree 142, the software displays in area 148 a list of content document nodes linked to the selected guidance node.

This embodiment also includes a detail area shown as area 149. As a node is selected in the tree 142, the software causes detailed information for the selected node to be displayed in area 149. A text editor to modify the content of a selected content node, and/or or a text viewer to display guidance for a selected guidance node can also be displayed. Area 149 can also be used to display a list or properties for the selected node such as the author and date of last modification. Accordingly, in this embodiment, the software can simultaneously display and associate the hierarchy of the master document, the hierarchy of the guidance document, the details of the guidance document corresponding to the user selected section/node, and the content of the selected section/node. The user can quickly view all of this information and, due to the linked data, can switch between sections/nodes to view, with automatic display of corresponding guidance.

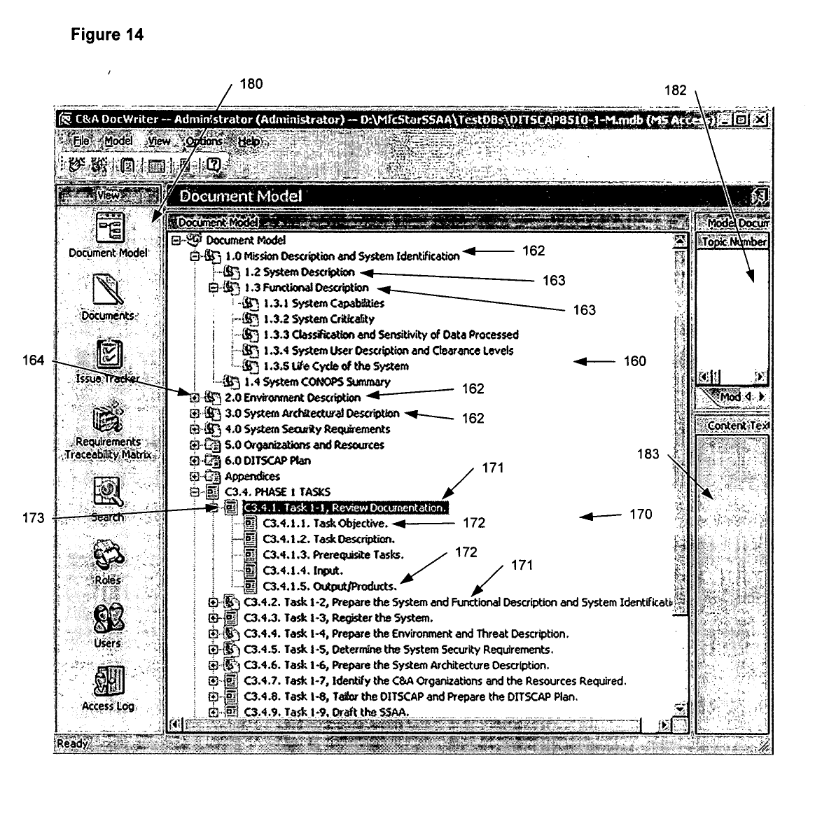

FIG. 14 illustrates an example of a computer display showing an example of a master document structure along with corresponding guidance document structure, similar to the example of FIG. 6. Here, the master document hierarchy is displayed in upper area 160 while the related guidance for that hierarchy is displayed in area 170. Each section 162 of the hierarchy of both the master document can be expanded to review subsections 163 thereof, such as by using button 164. Likewise, each task 171 to be conducted in preparing each section of the master document is displayed in area 170. Each task 171 can have a hierarchy of subtasks or guidance explanations 172 that can be expanded and viewed, or removed, using button 173. Accordingly, the user can easily view both hierarchy of the master document and the hierarchy of the guidance. Also, clicking on a section of the master document in area 160 can automatically allow a corresponding section of guidance to be displayed in area 170.

In this example, the application has different “views” only one of which shows the tree of the document hierarchy. Each of the icons 180 at the left controls what is displayed in the application. Clicking an icon switches to a different view and shows or hides the tree as appropriate. For example, the users view may show a list of users currently using the application. The upper right hand box 182 shows detail information about the selected node in the master document hierarchy. It could be the list of revisions for document content, or it could be the list of guidance nodes linked to the selected node, or it could be a list of actions to be performed for that node. The lower right hand box 183 shows the guidance for the selected master document node, but only if there is guidance for that particular node.

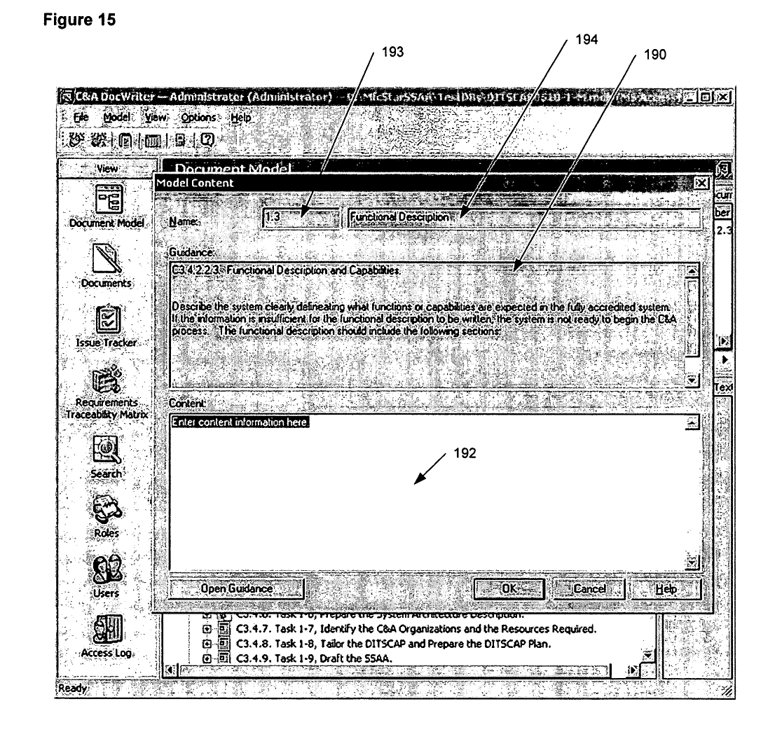

FIG. 15 illustrates an example of a computer display showing a content window for entering content for a section of the master document while simultaneously viewing guidance information for the section. Here, the window may be displayed upon clicking on a node of the master document hierarchy displayed in area 160 of FIG. 14. The identification number is displayed for the selected node in area 193 and the description of the selected node is displayed in area 194. Also, the guidance for the selected node is displayed in area 190. In addition, content for the selected node can be displayed in area 192, to allow the user to enter text for that node or otherwise link or provide a subdocument to be used for the node.

The foregoing description of various embodiments and principles of the inventions has been presented only for the purposes of illustration and description. It is not intended to be exhaustive or to limit the inventions to the precise embodiments disclosed. Many alternatives, modifications and variations will be apparent to those skilled in the art. Moreover, although multiple inventive aspects and principles have been presented, these need not be utilized in combination, and various combinations of inventive aspects and principles are possible in light of the various embodiments provided above. Accordingly, the above description is intended to embrace all possible alternatives, modifications, aspects, combinations, principles, and variations that have been discussed or suggested herein, as well as all others that fall within the principles, spirit and broad scope of the inventions as defined by the claims.

What is claimed is:

1. A graphical user interface (GUI) for viewing and editing a master document having an ordered relationship and for viewing at least one guidance document, the GUI comprising:
a first area for displaying a hierarchical model indicating the division of a master document into a plurality of subsections;
a second area for displaying a guidance information, wherein the guidance information comprises information corresponding to one or more suggestions for creating content of the subsections of the master document; and
a control for use in selecting the master document and/or the guidance information for display such that selection of one subsection of the master document in the first area causes the display of a corresponding guidance information in the second area.

2. The GUI as recited claim 1, further comprising an area for displaying tasks to be completed for the master document adjacent sections of the master document.

3. The GUI as recited in claim 1, further comprising
a third area for displaying an editor to indicate content to be provided for the selected subsection of the document, the content comprising one or more computer readable files.

4. The GUI as recited in claim 1, wherein the files are assembled to form the master document.

5. The GUI as recited in claim 1, wherein the guidance information includes a hierarchy of a guidance document, and wherein the GUI is simultaneously accessible by a plurality of users via at least one of client/server network and an Internet based network.

6. A computer readable medium having encoded thereon a method for generating a document, the method comprising
displaying a hierarchy indicating the organization of a master document, the hierarchy including an indication of the sections of the master document;
receiving an input from a user indicating a selection of one the sections; and
in response to the input, displaying at least a portion of a guidance document, the portion displayed including instructions for authoring the selected section of the master document.

7. The medium as recited in claim 6, wherein the method further comprises:
displaying an editor for use in creating information for the selected section of the master document.

8. The medium as recited in claim 6, wherein the method further comprises:
receiving tasks corresponding with each section of the master document, the tasks providing instructions to authors regarding the section to be developed; and
displaying the tasks in the hierarchy, adjacent to the sections of the master document.

9. The medium as recited in claim 8, wherein the method is executed via at least one of a client and server architecture, and an Internet based network.

10. A computerized method for authoring a complex document, the method comprising:
displaying a hierarchy for a master document to be generated, the hierarchy including sections of the master document, each section defining a particular topic to be addressed in the document;
receiving selection inputs from multiple separate users, the selection inputs indicating selections of one or more sections of the master document;
receiving subdocuments from each of the multiple separate users, the subdocuments representing content to be placed at the corresponding selected section of the master document; and
automatically linking all of the subdocuments to form the master document.

11. The method as recited in claim 10, wherein the method is executed via at least one of a client and server architecture, and an Internet based network.

12. The method as recited in claim 10, further comprising:
displaying tasks in the hierarchy adjacent corresponding sections of the document, the tasks providing instructions to authors regarding the section to be developed.

13. The method as recited in claim 10, further comprising:
displaying a hierarchy of a guidance document simultaneously with the hierarchy of the master document, the guidance document providing instructions for creating a section of the master document.

14. A computerized method for authoring a complex document, the method comprising:
displaying a hierarchy for a master document to be generated, the hierarchy including sections of the master document, each section defining a particular topic to be addressed in the document;
receiving subdocuments for each section of the master, the subdocuments comprising computer files; and
automatically assembling the subdocuments to form a single master document.

15. The method as recited in claim 14, wherein the subdocuments are assembled using an object embedding process.

16. The method as recited in claim 15, wherein the object embedding process is carried out using an OLE process.

17. A graphical user interface (GUI) for viewing and editing a master document having an ordered relationship and for viewing at least one guidance document, the GUI comprising:
a first area for displaying and permitting editing of a hierarchical model indicating the organization of a master document into a plurality of subsections, wherein at least one subsection is displayed adjacent to a task providing instructions to authors regarding the section to be developed, wherein the first area permits selection of one or more sections;
a second area for displaying guidance information comprising suggestions for creating content of sections of the master document, wherein the guidance information displayed in the second area is dependent upon the section of the hierarchical model displayed in the first area;
a third area for displaying an editor to indicate content to be provided for the selected section of the model, the content comprising one or more computer readable files.

18. The GUI as recited in claim 17, wherein the GUI is displayed via at least one of a client server network and an Internet based network.

19. A computerized method for authoring a complex document, the method comprising:
displaying a hierarchy for a master document to be generated, the hierarchy including sections of the master document, each section defining a particular topic to be addressed in the document;
displaying tasks in the hierarchy adjacent corresponding sections of the master document, the tasks providing instructions to authors regarding the section to be developed.
receiving selection inputs from multiple separate users via a network, the selection inputs indicating selections of one or more sections of the master document;
in response to each selection input, displaying to the corresponding user at least a portion of a guidance document, wherein the portion displayed including instructions for authoring the selected section of the master document;
receiving computer files from each of the multiple separate users, the files representing content to be placed at the corresponding selected section of the master document; and
assembling all of the files to form the master document.

20. The method as recited in claim 19, further comprising:
displaying an editor to receive inputs from the user to indicate the computer file to be used for the selected section.
